(19) United States
(12) Patent Application Publication
(10) Pub. No.: US 2008/0181286 A1
(43) Pub. Date: Jul. 31, 2008

(54) Hand-held wireless device with a PCIE interface

(76) Inventor: Chung-Yi Chen, Pingchien City (TW)

Correspondence Address: Hershkovitz & Associates, LLC, 2845 Duke Street, Alexandria, VA, 22314, US

(21) Appl. No.: 11/785,508

(22) Filed: Apr. 18, 2007

(30) Foreign Application Priority Data
Jan. 25, 2007 (TW) 096102806

(51) Int. Cl. H04B 1/38

(52) U.S. Cl. 375/220

(57) ABSTRACT

A hand-held wireless device with the PCI Express interface has a body, a PCI Express connector formed on end of the body, a control module mounted in the body and connected to the PCI Express connector, and multiple operating buttons mounted on the body. The control module has a wireless communication unit and a digital signal processor for wirelessly receiving and transmitting signals and processing data. The hand-held wireless device can be inserted to a PCI Express port of an electronic apparatus. When in use, the hand-held wireless device is detached from the electronic apparatus and communicates with the electronic apparatus through the wireless communication unit. The hand-held wireless device can be used as a wireless telephone, a game pad or an input device.

### BACKGROUND OF THE INVENTION

1. Field of the Invention

The present invention relates to a hand-held wireless device, and more particularly to a hand-held wireless device that can be received in a PCI Express port of an electronic device.

2. Description of Related Art

Data transfer rate for conventional PCI bus in the computer approximates to 133 MB per second. The new PCI Express interface can provide 500 MB to 16 GB and uses the serial transmission technology of switch type peer to peer. The physical layer for data transmission consists of a lane formed by a transmission end (TX) together with a receiving end (RX). Each PCI Express has its own data transmission channel instead of sharing a common bus with others to avoid interference problems during data transferring. Thus the data transfer speed of new PCI Express is faster than conventional PCI bus.

The PCI Express supports the hot-plug that allows a PCI Express device can be connected to or removed from a computer without needing to shut off power. Further, the PCI Express also supports many useful functions such as power management, error reporting and virtual channel and has been widely applied in the personal computer, server or storage system. For example, the notebook computer is equipped with the PCI Express port for connecting to high-speed external peripheral devices.

With the foregoing advantages, the PCI Express port becomes a very common interface for most of personal and notebook computers. However, not all computer users have the same requirements. Business users do not frequently use the PCI Express port to connect other peripheral devices and leave the port idle.

Because of the low cost of the web phone, the number of web phone users is obviously increasing in recent years. The earphone and microphone are of the web phone standard equipment for computer users. However, in comparison with the normal telephones, the usage of the earphone and microphone is inconvenient for users.

### SUMMARY OF THE INVENTION

The objective of the present invention is to provide a hand-held wireless device that can wirelessly communicate with a computer and be used as a wireless telephone, a game pad or an input device. When the hand-held wireless device is not in use, the device is held in a PCI Express port of the computer and charged by the computer.

To achieve the objective, the hand-held wireless device comprising:

a body having a size matching a standard of PCI Express peripheral device and having a PCI Express connector formed on one end of the body for connecting to an PCI Express port of an electronic apparatus;

a control module mounted in the body and comprising
a wireless communication unit;
a digital signal processor communicating with the wireless communication unit and having output pins and input pins; and
a power unit connected to the PCI Express connector to be charged by the electronic apparatus through the PCI Express connector and supply operating voltages to the wireless communication unit and the digital signal processor;

multiple buttons mounted on the body;

a speaker mounted in the body and connected to the input pins of the digital signal processor; and

a microphone mounted in the body and connected to the output pins of the digital signal processor.

Other objectives, advantages and novel features of the invention will become more apparent from the following detailed description when taken in conjunction with the accompanying drawings.

### BRIEF DESCRIPTION OF THE DRAWINGS

FIG. 1 is an operational view of a hand-held wireless device in accordance with the present invention to be inserted to a PCI Express port;

FIG. 2 is a perspective view of the hand-held wireless device in accordance with the present invention;

FIGS. 3A-3N show a circuit diagram of a control module of the hand-held wireless device in accordance with the present invention;

FIG. 4 is an operational view of the hand-held wireless device being inserted to the PCI Express port;

FIG. 5A is a flow chart of the steps performed by a computer that links to the hand-held wireless device of the present invention; and

FIG. 5B is a flow chart of the steps performed by the hand-held wireless device of the present invention that links to the computer.

### DETAILED DESCRIPTION OF THE PREFERRED EMBODIMENT

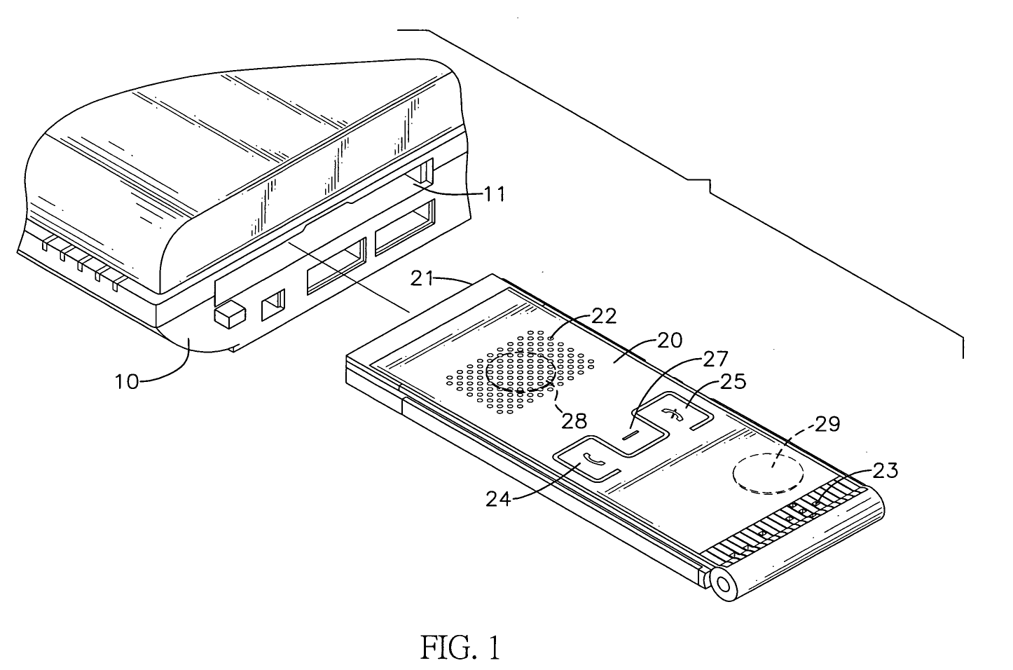

With reference to FIG. 1, a hand-held wireless device in accordance with the present invention can be held in an electronic apparatus such as a notebook computer (10) in this embodiment. The notebook computer (10) has at least one PCI Express port (11) for holding and electronically linking to the hand-held wireless device.

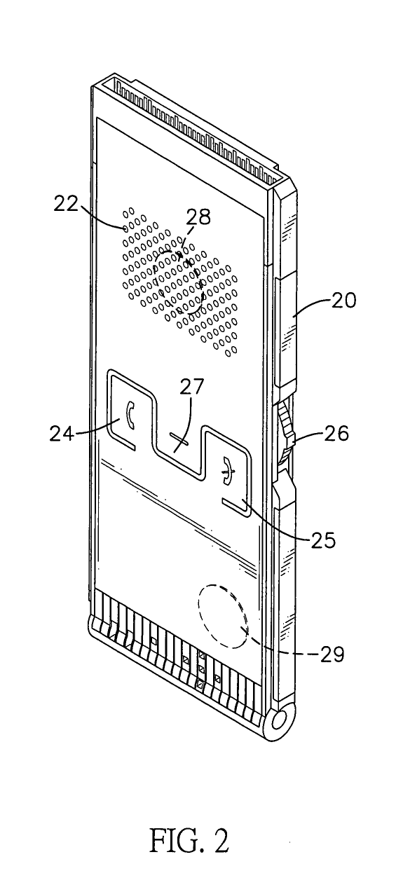

With further reference to FIG. 2, the hand-held wireless device comprises a body (20), a PCI Express connector (21), multiple sound output holes (22), multiple sound receiving holes (23), a speaker (28), a microphone (29) and multiple buttons such as an answer button (24), a hang up button (25) and a volume tuner (26).

The body (20) in this embodiment is a flat and rectangular body with a size matching the PCI Express port (11) of the notebook computer (10). The body (20) has a front end, a distal end, a top surface and a first side. The PCI Express connector (21) is formed on the front end of the body (20) for electronically connecting to the PCI Express port (11).

The multiple sound output holes (22) and the sound receiving holes (23) are defined on the top surface of the body (20) respectively corresponding to the speaker and the microphone that are mounted in the body (20). Both the answer button (24) and the hang up button (25) are formed on the top surface of the body (20). The volume tuner (26) is mounted on the first side of the body (20). In addition to the foregoing buttons, the body (20) can further include a function button (27) that accompanying with the volume tuner (26) controls an application program being executing by the notebook computer (10).

The hand-held wireless device in this embodiment is used as a wireless telephone for web phone communications, and a control module is mounted in the body (20).

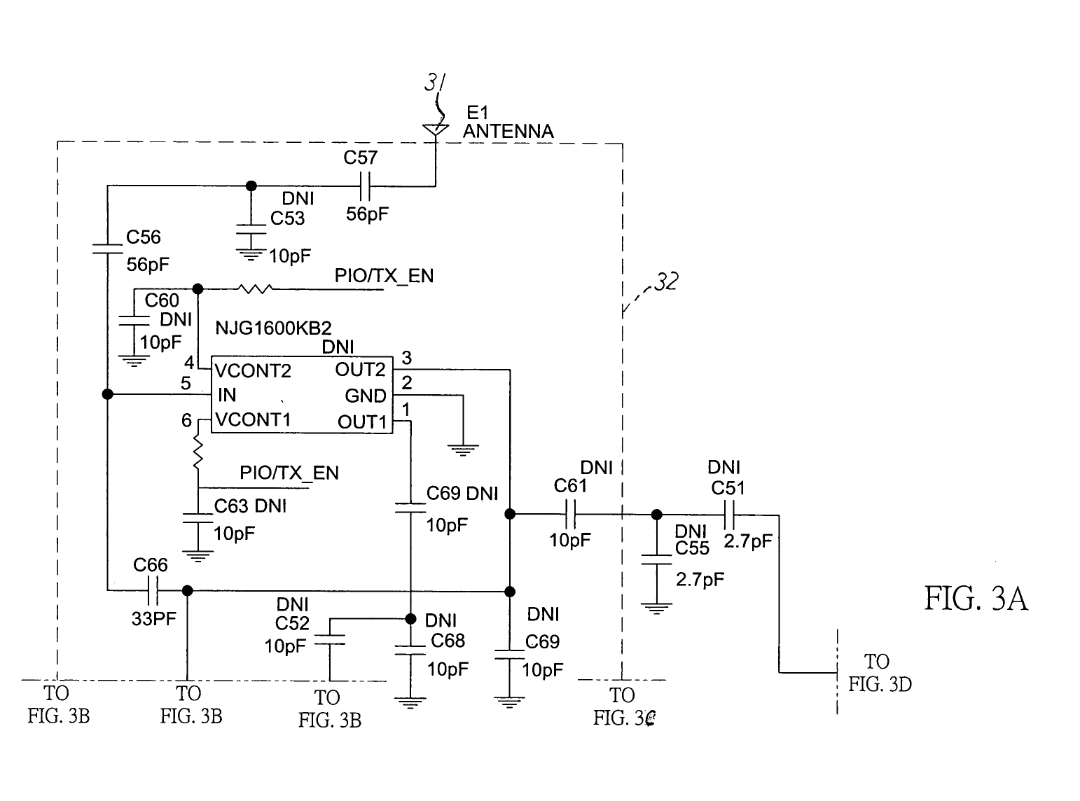

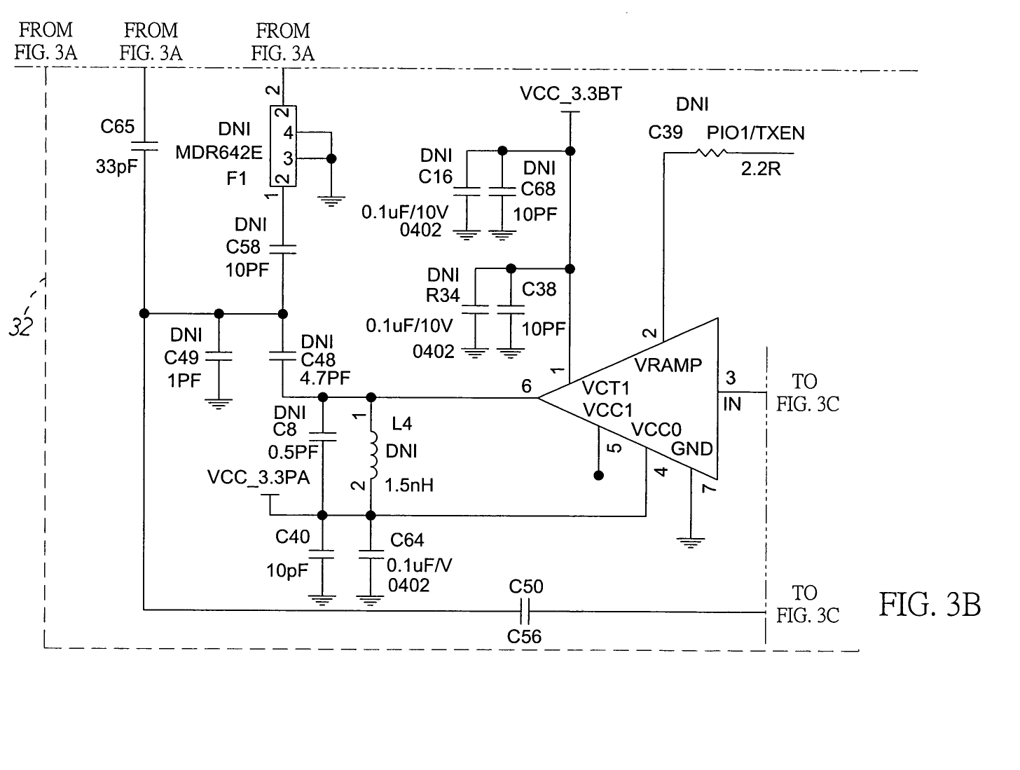

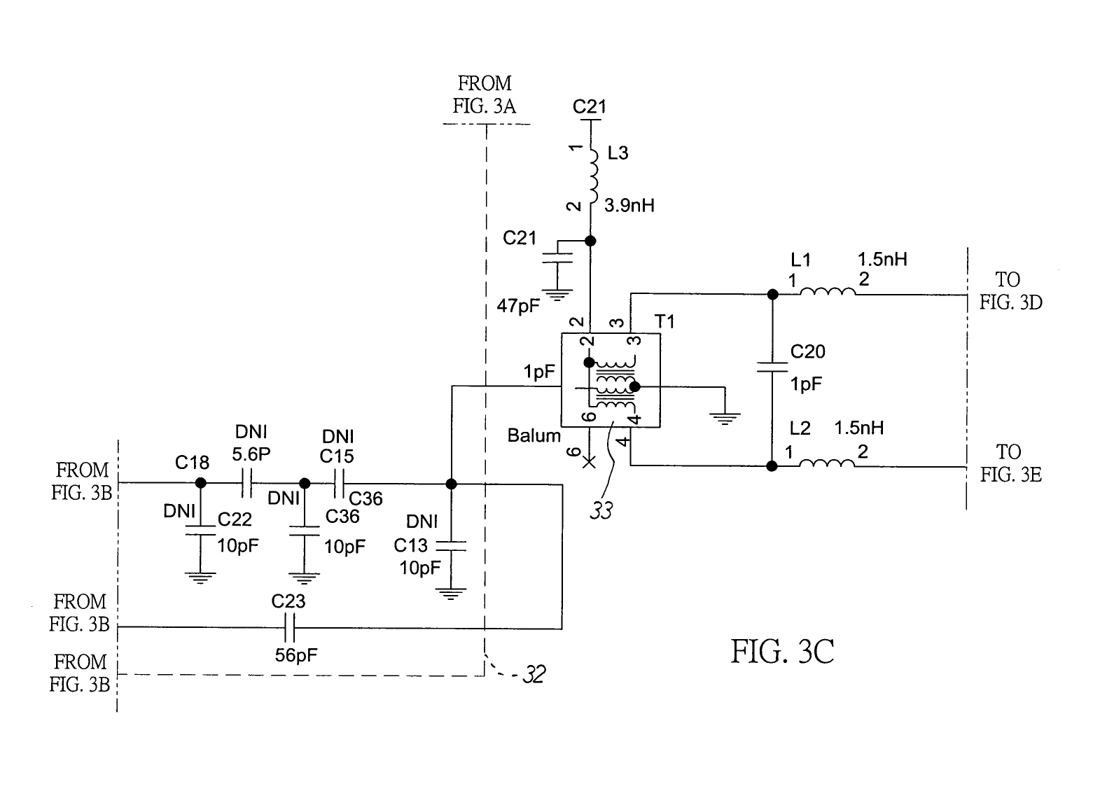

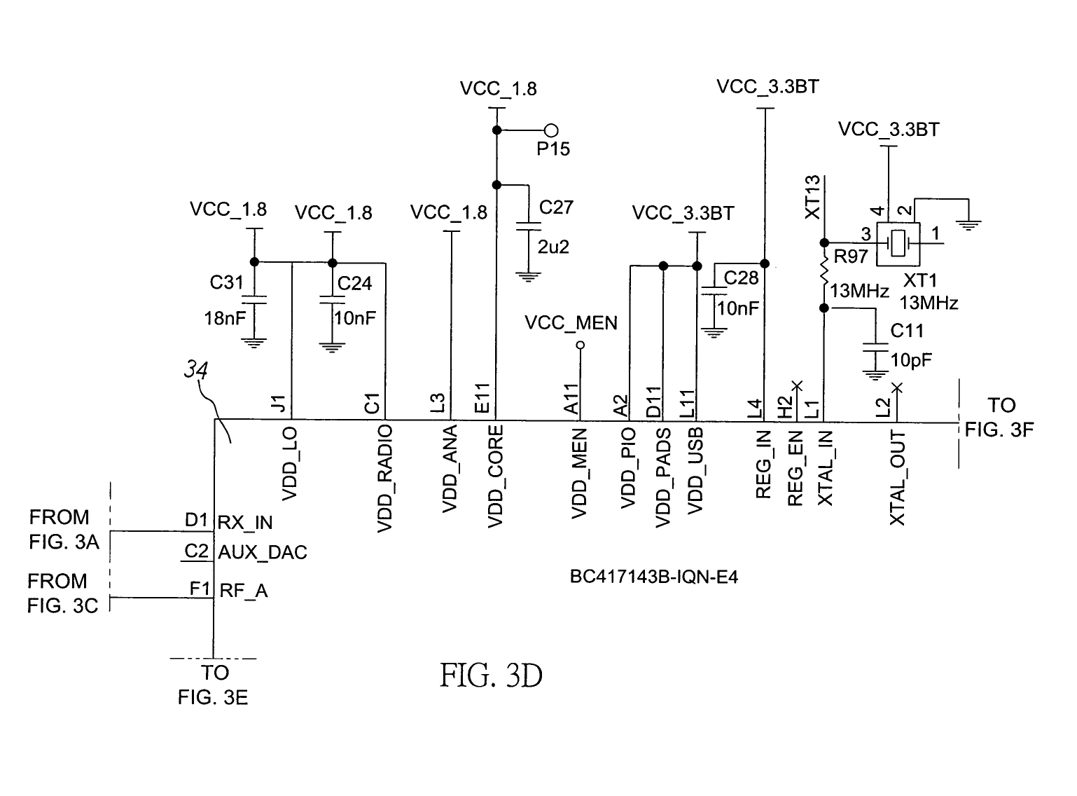

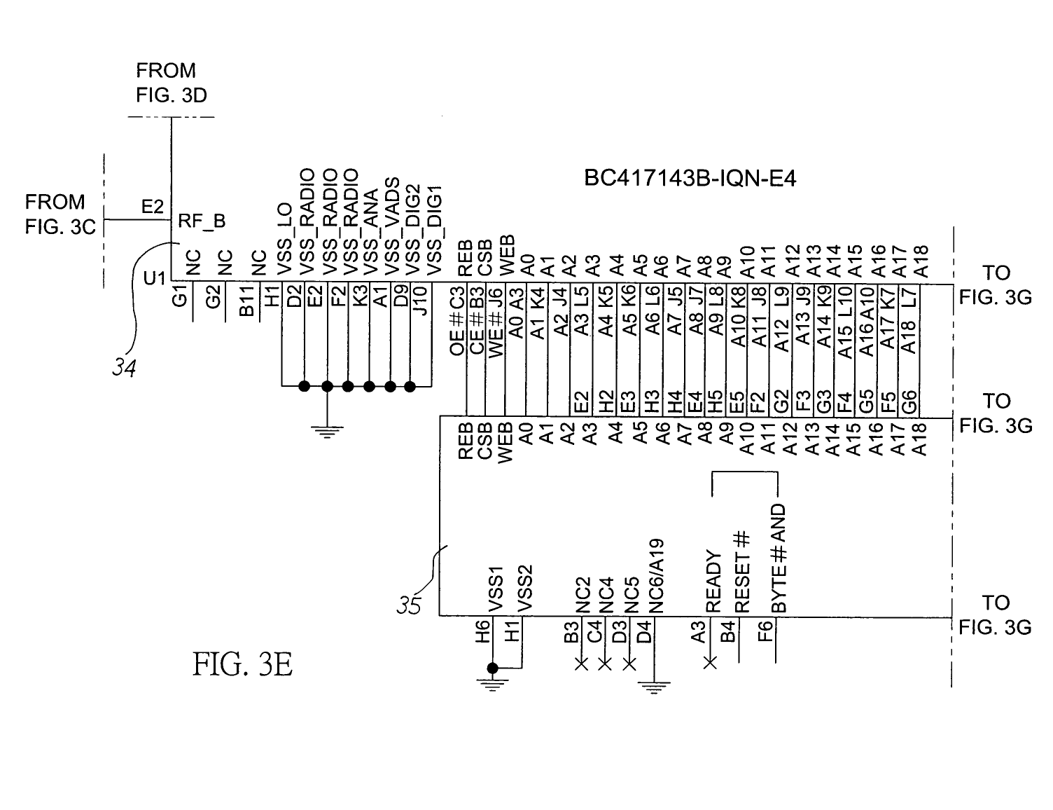

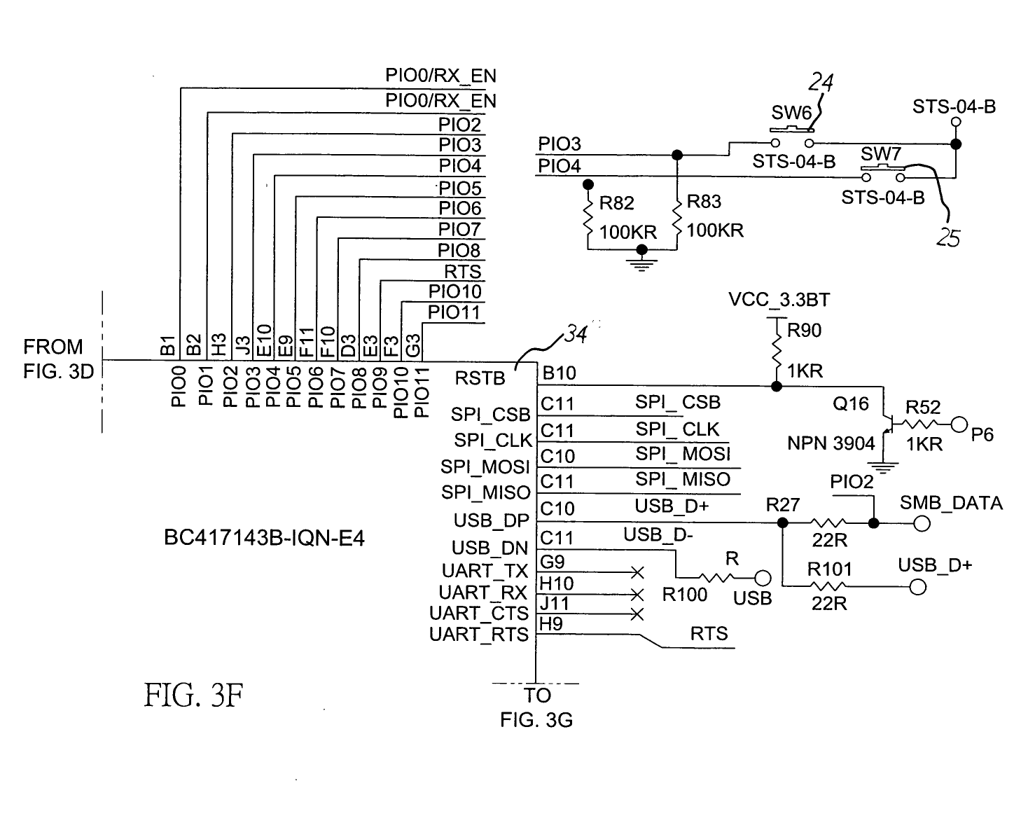

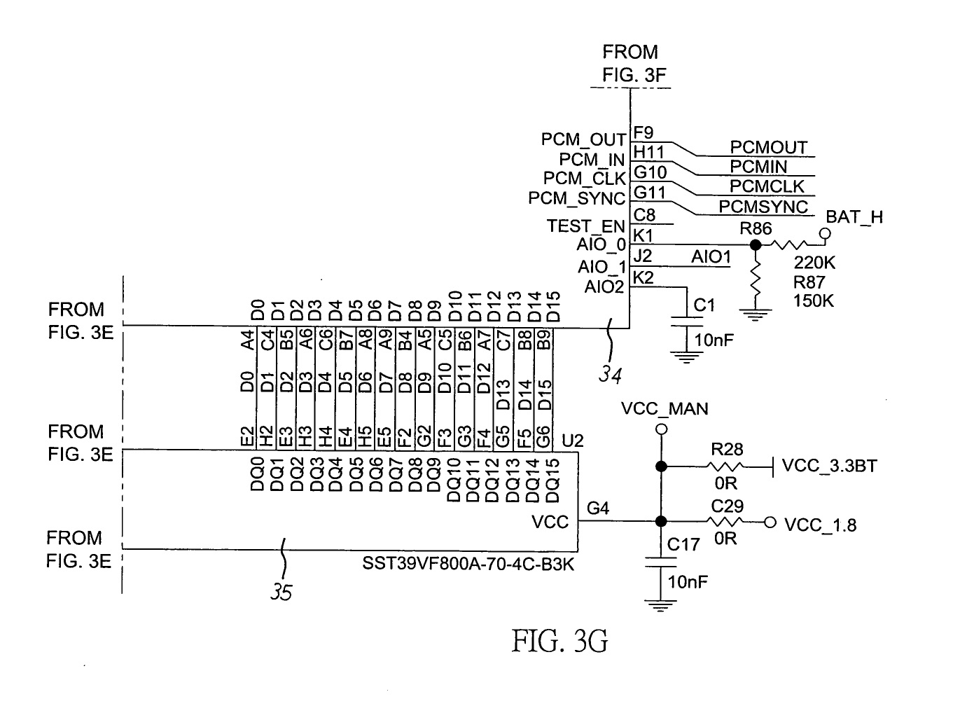

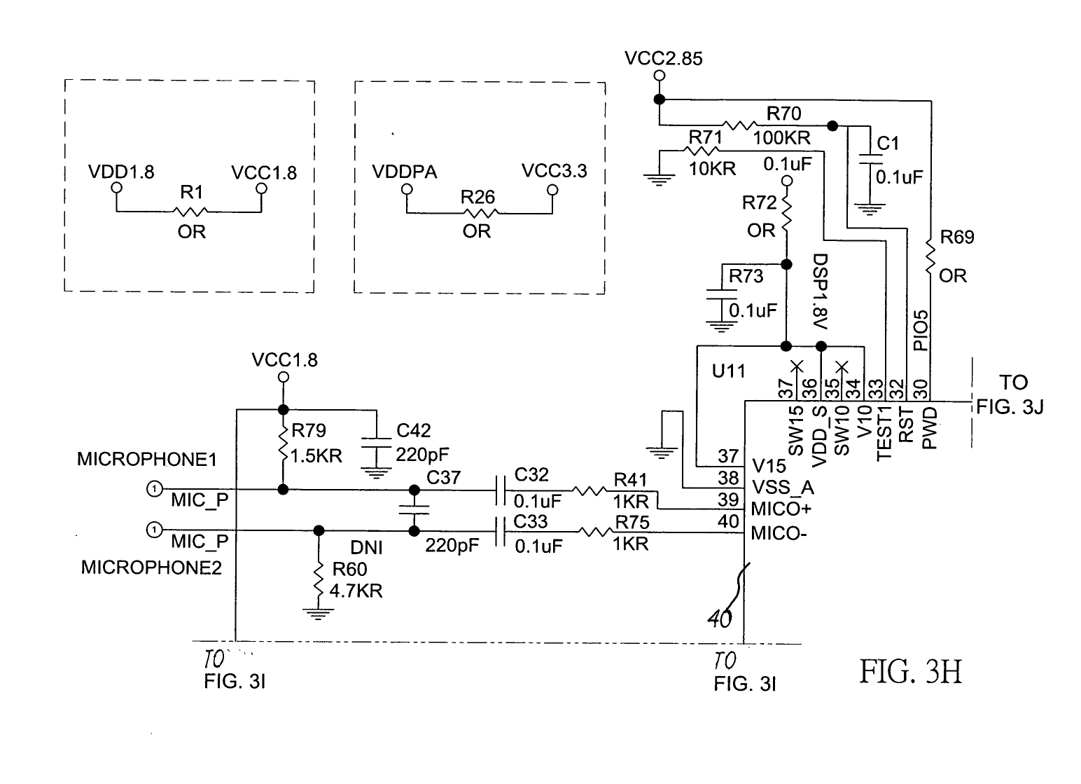

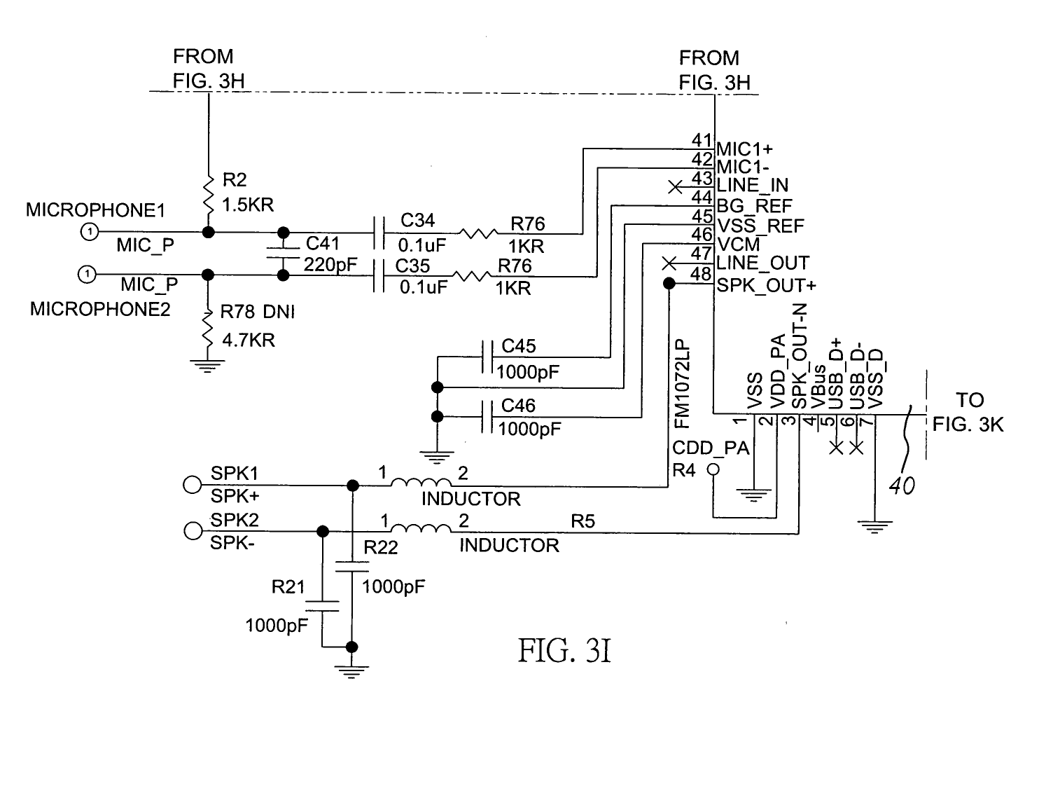

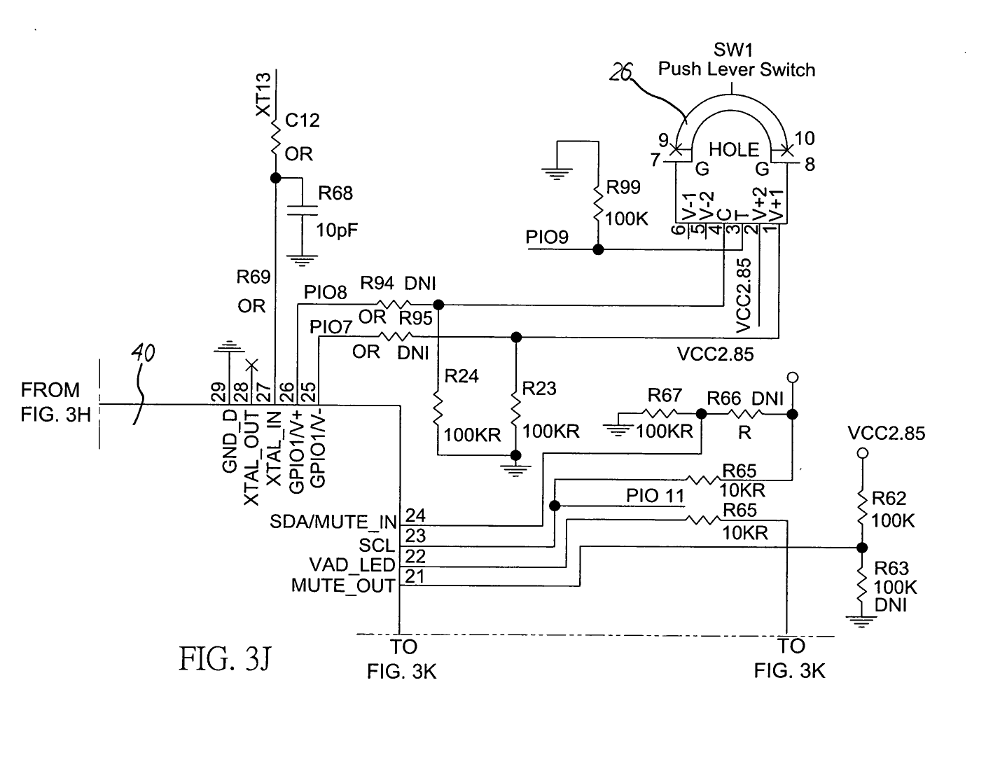

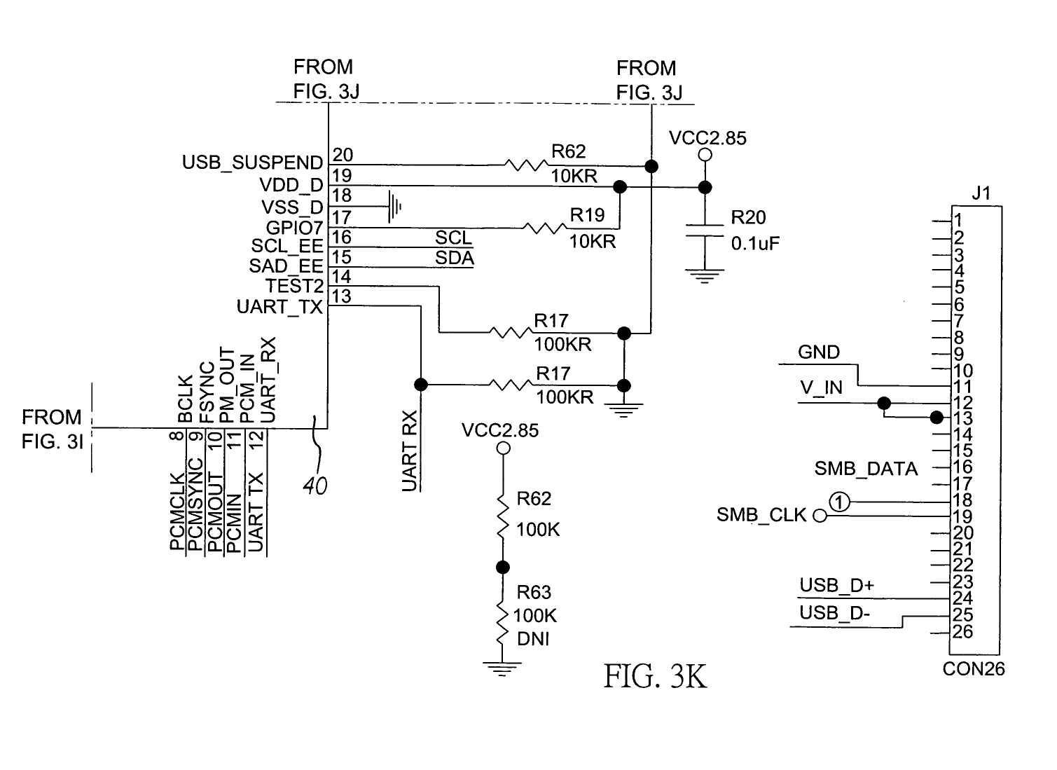

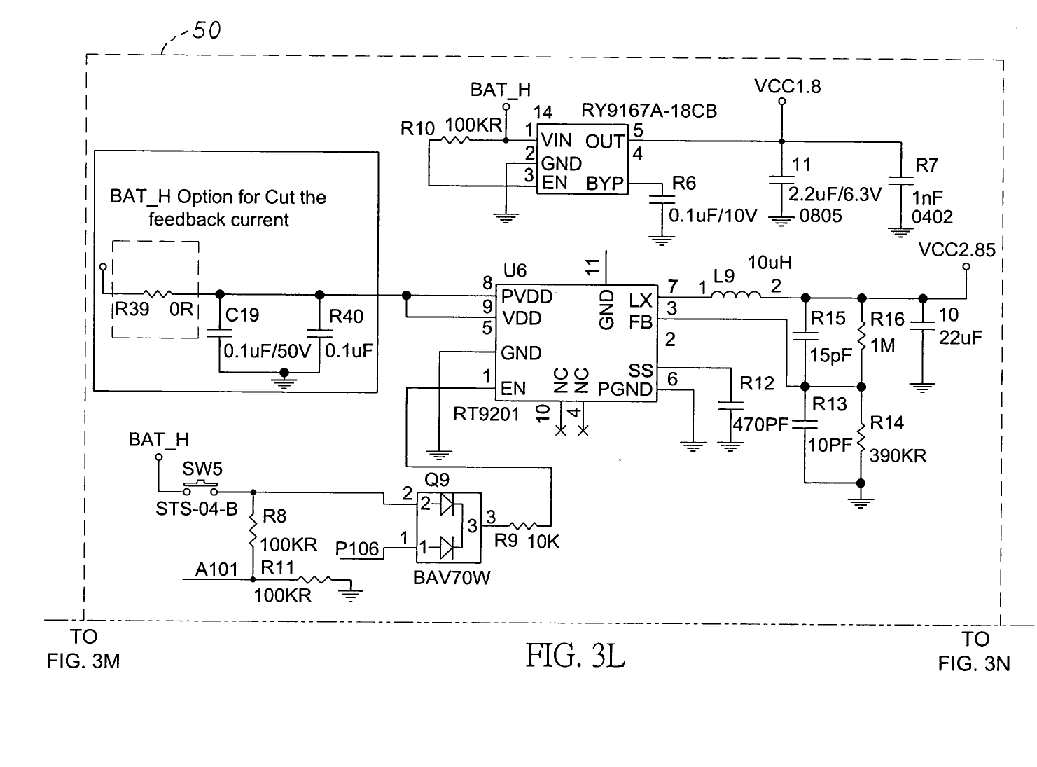

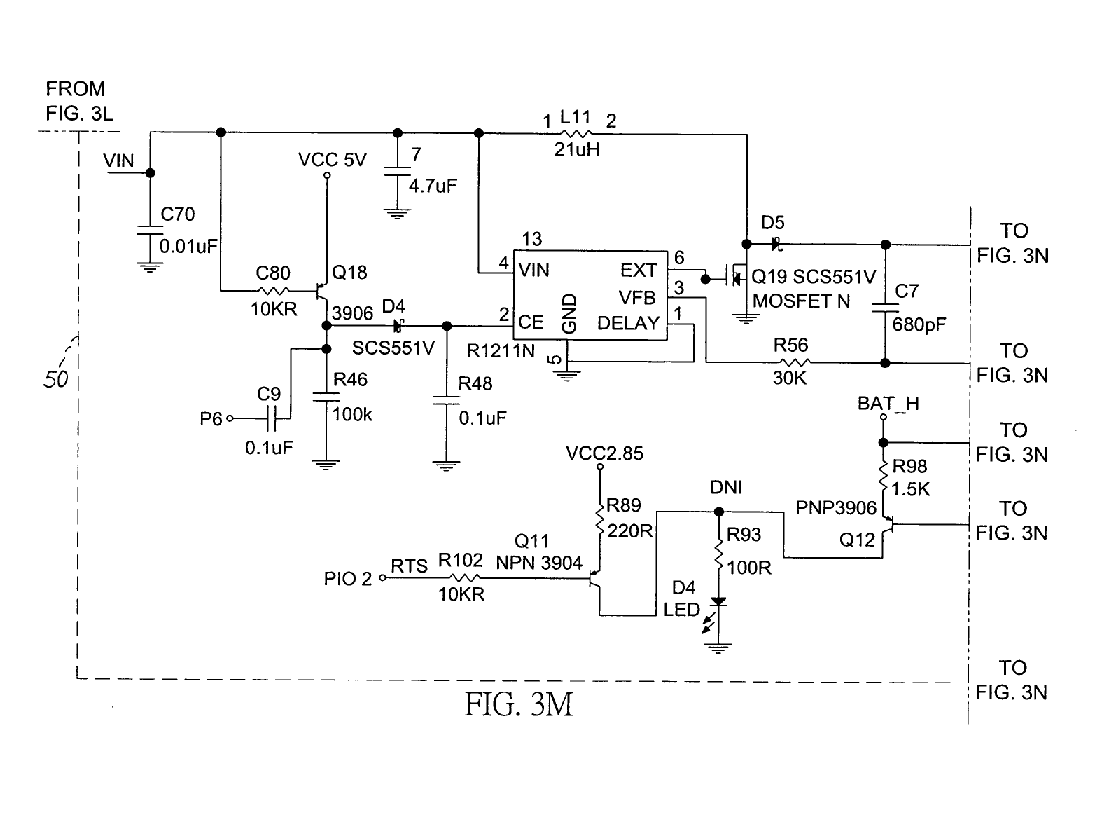

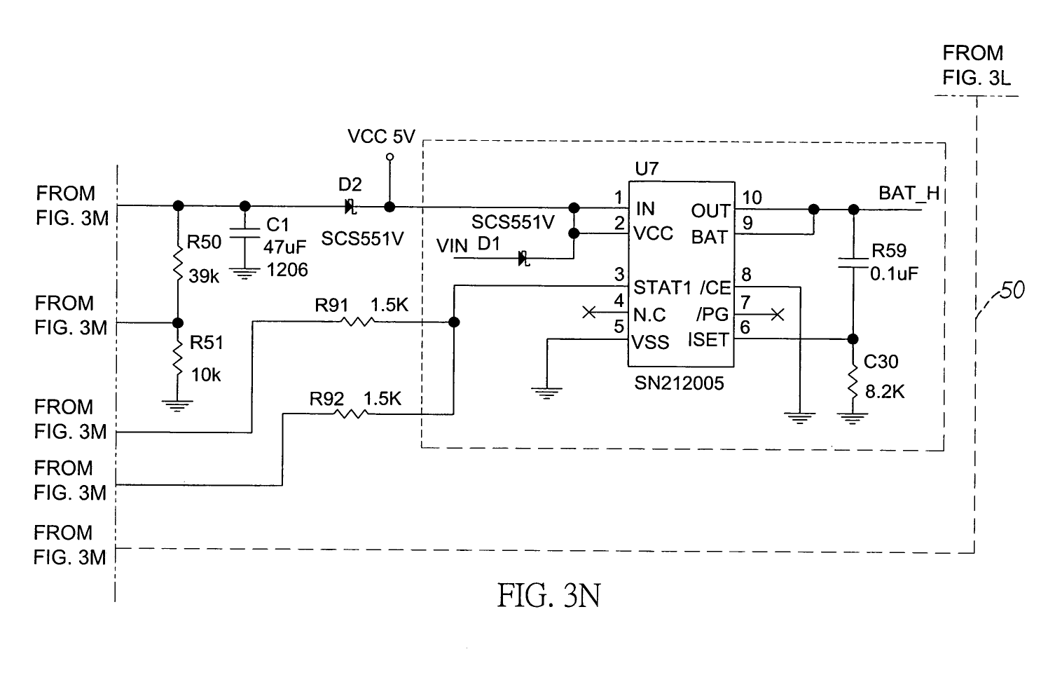

With reference to FIGS. 3A-3N, the control module comprises a wireless communication unit (30), a digital signal processor (DSP) (40) and a power unit (50).

The wireless communication unit (30) includes an antenna (31), a filtering circuit (32), an unbalanced transformer (33), a bluetooth controller (34) and a flash memory (35). The input/output pins of the bluetooth controller (34) are through the unbalanced transformer (33) and the filtering circuit (32) connected to the antenna (31) to transmit/receive wire signals. Further, two input pins PIO3 and PIO 4 of the bluetooth controller (34) are respectively connected to the answer button (24) (SW6) and the hand on button (25) (SW7). The flash memory (35) is connected to the blue tooth controller (34) to store the received or transmitted data.

The DSP (40) connects to the bluetooth controller (34) with multiple pins (PCMOUT, PCMIN, PCMCLK and PCMSYNC) for bi-directional data transmission. Moreover, GPIO0/V+ and GPIO1/V− pins of the DSP (40) are connected to the volume tuner (26). The volume tuner (26) further connects to the bluetooth controller (34) to adjust the communication volume.

The power unit (50) with input pins connects to the PCI Express connector (21). Through the PCI Express connector, the power unit (50) can be charged to store electricity for supplying operating voltages to the wireless communication unit (30) and the DSP (40).

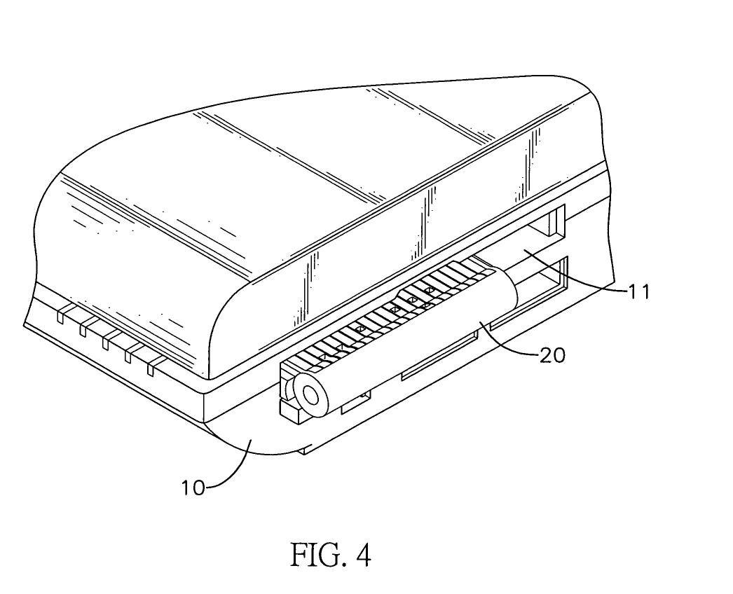

With reference to FIG. 4, when the body (20) of the hand-held wireless device is inserted to the PCI Express port (11), most of the body (20) is held inside the port (11) and only the distal end is exposed. When the device has to be detached from the notebook computer (10), a user can grab the exposed distal end and pull the body (20) outward. After the wireless device is inserted in the notebook computer (10), the wireless device is also charged through the PCI Express interface to store enough electricity.

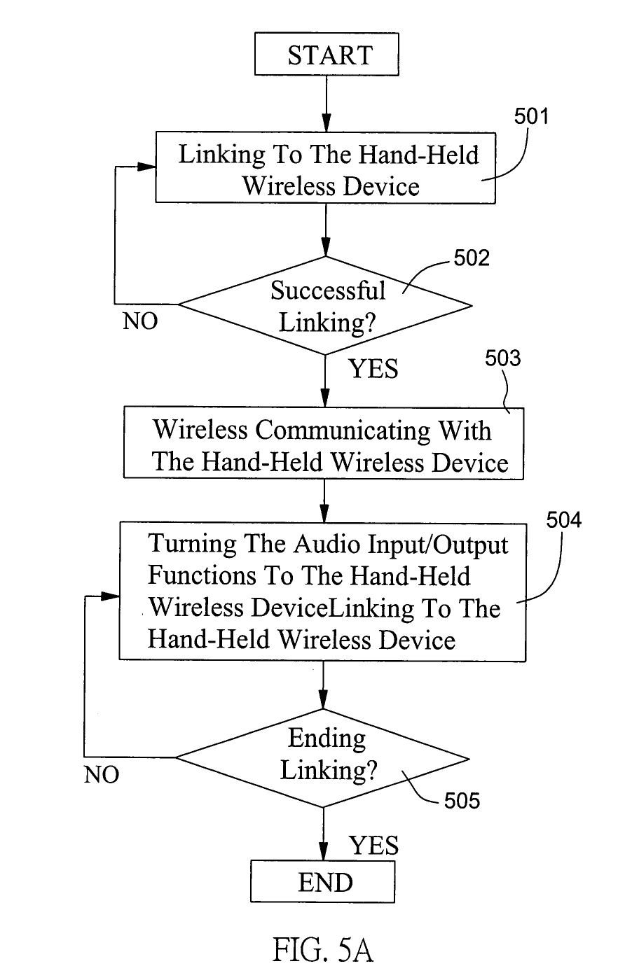

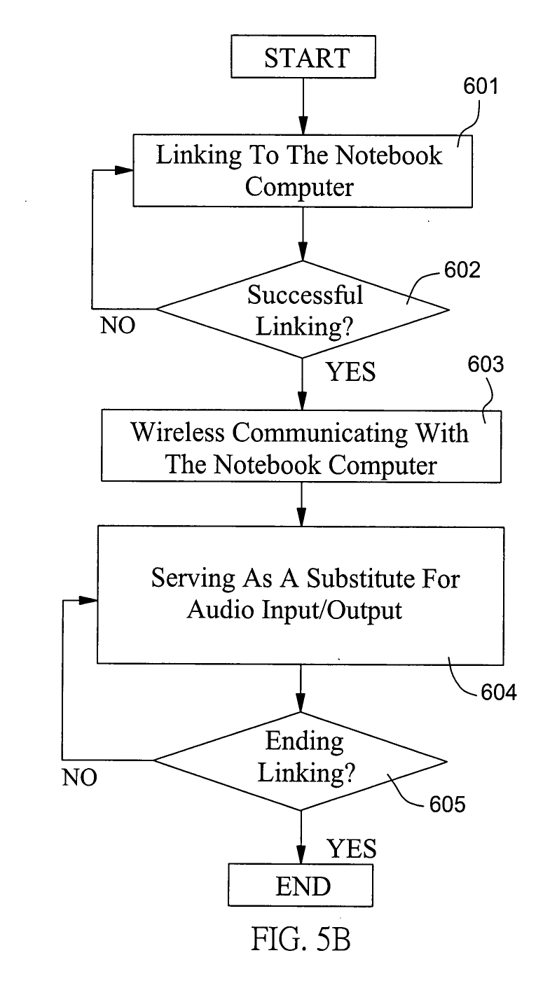

Even the wireless device is disconnected from the notebook computer (10), the wireless device can be used as a wireless telephone after an wireless communication is establish between the device and the computer. With reference to FIGS. 5A and 5B, after the hand-held wireless device is activated, the device starts to link to the notebook computer (10) (501)(601) and then determines whether or not the link is successful (502)(602). If a successful link is established, both the notebook computer (10) and the wireless device enter a wireless communication mode (503)(603). A wireless module of the notebook computer (10) wirelessly communicates with the hand-held device so that the audio input and audio output functions, which are originally performed by the notebook computer (10), turn to be performed by the hand-held device (504). In other words, the hand-held device serves as a substitute for audio input and audio output. A local user can directly use the hand-held device to talk with a remote web phone user (604). Then, the notebook computer (10) and the hand-held wireless device determine whether the communication between each other finishes.

In the foregoing embodiment, a wireless telephone is taken as an example. However, because the hand-held wireless device is provided with additional function keys and basic operating/input abilities, it can be used as a wireless game pad or a remote control of the computer. The wireless device also can be integrated with a laser pointer to add additional purposes.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A hand-held wireless device with a PCI Express interface, the hand-held wireless device comprising:
a body having a size matching a standard of PCI Express and having a PCI Express connector formed on one end of the body for connecting to an PCI Express port of an electronic apparatus;
a control module mounted in the body and comprising
a wireless communication unit;
a digital signal processor communicating with the wireless communication unit and having output pins and input pins; and
a power unit connected to the PCI Express connector to be charged by the electronic apparatus through the PCI Express connector and supply operating voltages to the wireless communication unit and the digital signal processor;
multiple buttons mounted on the body;
a speaker mounted in the body and connected to the input pins of the digital signal processor; and
a microphone mounted in the body and connected to the output pins of the digital signal processor.

2. The hand-held wireless device with a PCI Express interface as claimed in claim 1, the wireless communication unit comprising an antenna, a filtering circuit, an unbalanced transformer and a bluetooth controller, wherein the bluetooth controller is connected to the digital signal processor.

3. The hand-held wireless device with a PCI Express interface as claimed in claim 2, the buttons mounted on the body comprising
an answer button connected to the bluetooth controller;
a hand up button connected to the bluetooth controller; and
a volume tuner connected to the digital signal processor and the bluetooth controller.

4. The hand-held wireless device with a PCI Express interface as claimed in claim 3 further comprising a function key.

5. The hand-held wireless device with a PCI Express interface as claimed in claim 2, the bluetooth controller further connecting to a flash memory.
